(19) United States
(12) Patent Application Publication
(10) Pub. No.: US 2021/0078301 A1
(43) Pub. Date: Mar. 18, 2021

(54) LAMINATED GLAZING HAVING A FUNCTIONAL LAYER WITH IMPROVED LOW TEMPERATURE RESPONSE

(71) Applicant: AGP America S.A., Ciudad de Panama (PA)

(72) Inventors: Mario Arturo MANNHEIM ASTETE, Lima (PE); Andres Fernando SARMIENTO SANTOS, Lima (PE); Juan Pablo SUAREZ, Lima (PE); Jean-Marie LE NY, Lima (PE); Merlyn ROJAS VALLE, Lima (PE); Alfredo Daniel KOC LI, Lima (PE)

(21) Appl. No.: 16/770,490

(22) PCT Filed: Dec. 7, 2018
(86) PCT No.: PCT/IB2018/059793

§ 371 Date: Jun. 5, 2020

Related U.S. Application Data
(60) Provisional application No. 62/596,852, filed on Dec. 10, 2017.
(60) Provisional application No. 62/596,104, filed on Dec. 7, 2017.

(51) Int. Cl. B32B 17/10; H05B 3/86

(52) U.S. Cl. CPC B32B 17/10532; B32B 17/10036; B32B 17/10513; B32B 17/10137; B32B 17/1022; B32B 17/10229; H05B 3/86; B32B 17/10477; B32B 17/10486; B32B 17/10504; B32B 17/10633; B32B 17/10761; B32B 17/10385

(57) ABSTRACT

Functional layers do not have a good performance at lower temperatures. This limitation is overcoming by combining the functional layers with a resistive heating circuit. The heating circuit uses minimal power to maintain the glazing at or above the temperature required for acceptable operation.

### FIELD OF THE INVENTION

This invention relates to the field of laminated automotive glazing.

### BACKGROUND OF THE INVENTION

In response to the government regulatory requirements for increased automotive fuel economy, as well as the growing public awareness and demand for energy efficient environmentally friendly products, automotive original equipment manufacturers, around the world, have been working to improve the energy efficiency of their vehicles.

One of the key elements of this strategy to improve efficiency has been the concept of light weighting and solar control. Often times, more traditional, less expensive, conventional materials and processes are being replaced by innovative new materials and processes which while sometime being more expensive, still have higher utility than the materials and processes being replaced due to their lower weight and the corresponding increase in fuel efficiency. Sometimes, the new materials and processes bring with them added functionality as well in addition to their lighter weight. Vehicle glazing has been no exception.

By reducing the weight of the vehicle substantial improvements can be made in energy consumption. This is especially important for electric vehicles where the improvement directly translates into an increase in the range of the vehicle which is a key consumer concern.

For many years, the standard automotive windshield had a thickness of 5.4 mm. In more recent years, we have seen the thickness decrease to 4.75 mm. While a reduction of 0.65 mm may not seem significant, at a density of 2600 kg per cubic meter for the typical standard soda-lime float glass, each millimeter that the thickness is reduced, decreases the weight by 2.6 kg per square meter. The weight of a typical 1.2 square meter windshield going from 5.4 mm to 4.75 mm is reduced by a little over 2 kg. On a vehicle with a total of 6 square meters of glass, a 1 mm reduction on all of the windows translates into a savings of 15.6 kg.

In addition, the glazed area of vehicles has been steadily increasing and, in the process, displacing other heavier materials. The popular large glass panoramic roofs are just one example of this trend. A panoramic windshield is a windshield on which the top edge has been substantially extended such that it comprises a portion of the vehicle roof.

However, there are limits as to have thin the glazing can be using annealed soda-lime glass. Stress under wind load has always been a factor. With the trend towards increasing the size of windshields in particular, wind load is even more of a concern. Glass is also becoming a structural element in more and more vehicles. The glazing contributes to the stiffness and strength of the car. Fixed glass, once bonded with a relatively soft curing poly-urethane, is being mounted with higher modulus adhesives. As a result, the glass, once isolated by rubber gaskets and soft butyl adhesives, is now much more subject to loading from the bumps in the road and vehicle torsion.

Today, windshields with a 2.1 mm outer ply, a 1.6 mm inner ply and a 0.76 mm plastic interlayer totaling just under 4.5 mm in total thickness are becoming common. This may be close to the limit of what can be done with conventional annealed soda-lime glass.

The use of thinner glass and the use of chemically tempered glass has been among the key technologies used to reduce the thickness and weight of the glazing.

While a number of factors influence the transmission of sound, among the most important are density and mass. As density and mass are reduced, the level of sound transmitted increases. As an automotive glazing is made thinner and lighter, sound attenuation is degraded with the reduction in mass. Density also comes into play with some glass compositions commonly used for chemical tempering that have a lower density than soda-lime glass.

Sound attenuation increases when the energy encounters a change in the density of the material that it is passing through. The change in density, going from glass to plastic to glass in a standard laminate, results in much better attenuation than in monolithic glazing of the same thickness.

One approach used to offset the degradation in attenuation resulting from the use of thinner and lighter glass, as well as to improve the attenuation of ordinary laminates, has been the use of acoustic interlayers in laminated glazing. Interlayers that can dampen sound, above and beyond the level of attenuation of a normal laminate, are comprised in whole or in part of a layer of plastic that is softer and more flexible than that normally used. A reduction of as much as 6 db at certain frequencies is typical.

A non-acoustic automotive PVB interlayer will have a typical glass transition temperature of ˜20 C whereas an acoustic PVB may have one as low as 0 C. At normal laminate assembly room temperatures (<20 C), an acoustic PVB interlayer can be difficult to work with. They tend to be very soft, limp and sticky making them difficult to handle and to position on the glass as the laminate is assembled. Lower than normal assembly room ambient temperatures are needed to assemble laminates that comprise these types of monolithic acoustic PVBs. To address this disadvantage, a number of triple layer interlayer products have been introduced. In the triple layer product, the softer material is sandwiched between two thin layers of the normal PVB material. The overall thickness remains similar to that of an ordinary PVB interlayer. Handling is similar to ordinary PVB interlayer.

One of the drawbacks of an acoustic PVB interlayer is that the performance drops off with temperature. At lower temperatures and acoustic interlayer is no better than a standard interlayer.

Likewise, by reducing the solar load on the vehicle substantial improvements can be made in energy consumption, especially in warmer climates, by reducing the load on the air conditioning unit and allowing operation of the vehicle with the windows closed which improves aerodynamics. This is especially important for electric vehicles where the improvement directly translates into an increase in the range of the vehicle.

Infrared absorbing and infrared reflecting glazing are the two primary technologies that are being used to improve solar control.

Infrared absorbing glass has a higher iron content than ordinary clear glass giving it a greenish tint. The iron compounds in the glass absorb solar energy. There are also plastics that can be used with laminated glass that contain solar energy absorbing compounds that can achieve the same effect. By absorbing the energy before it enters the passenger compartment, the solar load on the vehicle is reduced. While a heat absorbing window can be very effective in reducing the solar load, the glass will heat up and transfer some of the absorbed energy to the passenger compartment through convective transfer and radiation.

A more efficient method is to reflect the energy back to the atmosphere allowing the glass so stay cooler. This is done through the use of various infrared reflecting films and coatings.

Infrared coatings and films are generally too soft to be exposed to the elements. Instead, they must be fabricated as one of the internal layers of a laminated product to prevent damage and degradation of the film or coating. One of the advantages of a laminated window over a tempered monolithic glazing is that a laminate can make use of these infrared reflecting coatings and films in addition to heat absorbing compositions and interlayers.

It is common practice to use a combination of infrared absorbing and infrared reflecting technologies on the same laminate. An infrared absorbing layer is placed behind an infrared reflecting layer to absorb the reaming infrared that is not reflected.

Infrared reflecting coatings include but are not limited to the various metal/dielectric layered coatings applied though Magnetron Sputtered Vacuum Deposition (MSVD) as well as others known in the art that are applied via pyrolytic, spray, controlled vapor deposition (CVD), dip and other methods.

Infrared reflecting films include both metallic coated plastic substrates as well as organic based non-metallic optical films which reflect in the infrared. Most of the infrared reflecting films are comprised of a plastic film substrate having an infrared reflecting layered metallic coating applied.

One of the drawback of both heat absorbing and heat reflecting glazing is that the solar load reduction is present all the time even when it is not needed or desired. In colder climates and at times when heat is needed, it would be advantageous to have the capability to utilize the energy of the sun to heat the vehicle interior.

With internal combustion engines (ICE), heating was never a problem. Internal combustion engines are very inefficient and so abundant waste heat is available. A typical ICE powered vehicle has a heater with a capacity of 4-5 kW. In an electric vehicle, there is some waste heat from the battery but most if not all of the cabin heating must be provided by means of a resistive heating system.

It would be desirable to have a darker heat absorbing tint to keep the solar energy out to reduce the load on the air conditioning but to be able to let as much solar in a possible when heat is needed.

To control the level of light and energy transmission through the laminate, there are a number of technologies available: electrochromic, photochromic, thermochromic and electric field sensitive films which are designed to be incorporated into laminated glass. Of particular interest are electrochromic, suspended particle device (SPD) films and polymer dispensed liquid crystal (PDLC) films with which we can change the light transmittance of the glazing in response to an electrical signal.

SPD is a variable tint technology with which the level of tint can be controlled and varied in response to an applied electrical field. SPD goes from dark in the off state to less dark in the on state. In a SPD film, microscopic droplets of liquid containing needle like particles, light vales, are suspended in a matrix. In the off state the particles are in a random state of alignment and block the transmission of light. The degree of alignment and resulting tint can be varied in response to the applied voltage. The light transmittance in the on and off states can also be shifted through changes to the thickness and composition of the active material. In the off state, it is still possible to see clearly through SPD.

PDLC is a light scattering technology which goes from opaque in the off state to clear in the on state. In a PDLC film, microscopic droplets of liquid crystal are suspended in a polymer matrix. In the off state the liquid crystals are in a random state of alignment and scatter the light providing privacy. In the off state, the film is substantially opaque. When an electric filed is applied, the crystals align and allow light to pass. The degree of scattering can be varied by varying the amplitude of the applied voltage. The level of light transmittance in the on and off states can also be shifted by making changes to the thickness and composition of the active material. PDLC is primarily a privacy product though it can also be used for solar control as it reduces the solar energy transmitted.

SPD and PDLC glazing are both manufactured by adding a special film layer to the laminate. The film is comprised of the active material sandwiched between two thin plastic layers having a transparent conductive coating on each.

To incorporate into a laminate, sheets of plastic interlayer are needed on each side of the film so as to bond the film to the other layers of the laminate. The film is laminated in between two plastic bonding interlayer layers in order to form a laminated glazing.

Electrochromic switchable glazing undergoes a chemical reaction when a current is passed through the active material, in much the same way that a battery functions when it charges and discharges. The active material undergoes an oxidation or reduction reaction as the materials changes from light to dark and back. This is a relatively slow process with the switching time measure is minutes.

SPD and PDLC however operate on a different principle. There is no chemical reaction. The molecules that make up the active material undergo a kinetic change in response to the presence of an electrical field. This is why the switching time of SPD and PDLC is measured in seconds or factions of a second making it orders of magnitude faster than electro-chromic glazing. This is one of the primary advantage that the two have over electrochromic.

Electrochromic, SPD and PDLC can all be used for solar control as they reduce the level of light transmittance and energy transferred to the cabin.

Laminates that incorporate these variable light transmittance technologies are sometime referred to as “smart” glass or as switchable glazing.

One disadvantage is that smart glass can only operate over a limited range of temperature.

The viscosity of the microscopic droplets that the active material is suspended in (SPD) and of the liquid crystal itself (PDLC), is a function of temperature. As the temperature drops, the switching time increases. At sufficiently low temperatures the material is unable to change states. The actual temperature will depend upon the formulation.

At elevated temperatures, PDLC will reach a point where it will become clear and not switch to the light scattering state. SPD will still switch but the switching speed is much slower.

Electrochromic glazing, which is relatively slow to switch states, relies on a chemical reaction which also takes longer at lower temperatures.

As a result, the use of electrochromic, PDLC and SPD has been limited due to these temperature constraints.

It would be advantageous to produce a laminate with a functional layer, such a switchable layer and an acoustic interlayer, which can be able to maintain a good performance at lower temperatures.

### BRIEF SUMMARY OF THE INVENTION

The present invention aims to overcome the disadvantage of the state-of-art by providing a laminated glazing comprising an outer glass layer, an interior glass layer, a functional layer located between outer and inner glass layers, and at least one resistive heating circuit located between the functional layer and one of the glass layers, wherein said at least one resistive heating circuit provides heat to the functional layer to improve its response at low temperature.

A variety of means can be used including but not limited to: printed silver frit, conductive coated glass, conductive coated film and embedded wire. The heating circuit does not need to deice or defog and so can be designed to draw minimal power.

Advantages:
Extended lower temperature operation
Shorter switching time at lower temperatures.
Lower energy consumption.
Fabricated using standard automotive glass processes and equipment.

### BRIEF DESCRIPTION OF DRAWINGS

FIG. 1A Cross section of a typical automotive laminate.

FIG. 1B Cross section of a typical automotive laminate with coating and performance film.

FIG. 2 Exploded view of windshield with a variable light transmittance film.

FIG. 3 Exploded view of windshield with a variable light transmittance film and a screen print silver resistive heating circuit.

FIG. 4 Exploded view of windshield with a variable light transmittance film and a transparent conductive coated glass resistive heating circuit on surface two of glass.

FIG. 5 Exploded view of windshield with a variable light transmittance film and a transparent conductive coated film resistive heating circuit.

FIG. 6 Exploded view of windshield with a variable light transmittance film and an embedded wire resistive heating circuit.

FIG. 7 Exploded view of windshield with an acoustic PVB interlayer and a screen print silver resistive heating circuit.

FIG. 8 Exploded view of windshield with an acoustic PVB interlayer and a transparent conductive coated glass resistive heating circuit on the number two surface of glass.

FIG. 9 Exploded view of windshield with an acoustic PVB interlayer and a transparent conductive coated film resistive heating circuit.

FIG. 10 Exploded view of windshield with an acoustic PVB interlayer and an embedded wire resistive heating circuit.

### REFERENCE NUMERALS

4 Plastic Bonding Interlayer
6 Obscuration
12 Performance film
18 Coating
37 Bus bar
42 Coated Film
44 SPD film/Switchable Film
46 Silver Frit Heating Circuit
48 Tungsten Wire Heating Circuit
101 Surface one
102 Surface two
103 Surface three
104 Surface four
201 Outer glass layer
202 Inner glass layer

### DETAILED DESCRIPTION OF THE INVENTION

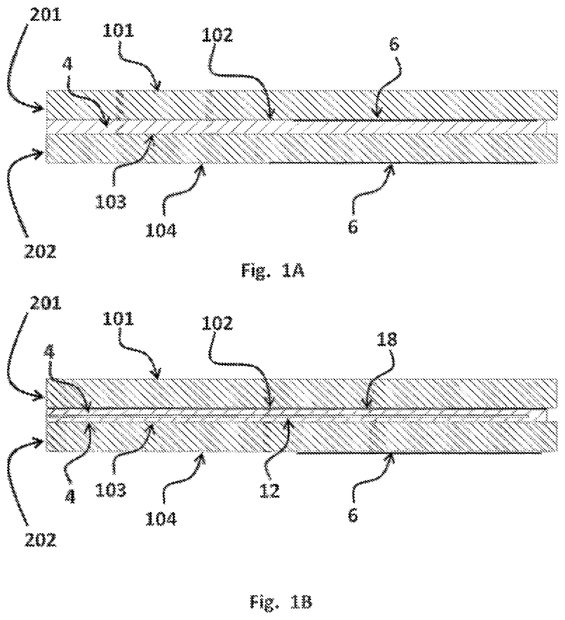

The following terminology is used to describe the laminated glazing of the invention. A typical automotive laminate cross section is illustrated in FIGS. 1A and 1B. The laminate is comprised of two layers of glass, the exterior or outer 201 and interior or inner 202 that are permanently bonded together by a plastic bonding interlayer 4. The glass surface that is on the exterior of the vehicle is referred to as surface one 101 or the number one surface. The opposite face of the outer glass layer 201 is surface two 102 or the number two surface. The glass surface that is on the interior of the vehicle is referred to as surface four 104 or the number four surface. The opposite face of the inner glass layer 202 is surface three 103 or the number three surface. Surfaces two 102 and three 103 are bonded together by the plastic bonding interlayer 4. An obscuration 6 may be also applied to the glass. Obscuration are commonly comprised of black enamel frit printed on either surface two 102 or surface four 104 or on both. The laminate may also comprise a coating 18 on one or more of the surfaces. The laminate may also comprise a performance film 12 laminated between at least two plastic bonding interlayers 4.

The plastic bonding interlayer has the primary function of bonding the major faces of adjacent layers to each other. The material selected is typically a clear plastic when bonding one glass layer to another glass layer 2. For automotive use, the most commonly used bonding interlayer is polyvinyl butyl (PVB). In addition to polyvinyl butyl, ionoplast polymers, ethylene vinyl acetate (EVA), cast in place (CIP) liquid resin and thermoplastic polyurethane (TPU) can also be used. Interlayers are available with enhanced capabilities beyond bonding the glass layers together.

The invention may include interlayers designed to dampen sound. Such interlayers are comprised whole or in part of a layer of plastic that is softer and more flexible than that normally used. The interlayer may also be of a type which has solar attenuating properties.

In several embodiments, the invention is comprised of at least one functional layer designed to dampen sound. Such interlayers are comprised whole or in part of a layer of plastic that is softer and more flexible than that normally used. In some embodiments, the functional layer is an acoustic PVB interlayer. Additional plastic interlayers and performance films may also be used in conjunction with the acoustic sound dampening interlayer.

Automotive plastic interlayers are made by an extrusion process with has a thickness tolerance and process variation. As a smooth surface tends to stick to the glass, making it difficult to position on the glass and to trap air, to facilitate the handling of the plastic sheet and the removal or air (deairing) from the laminate, the surface of the plastic is normally embossed contributing additional variation to the sheet. Standard thicknesses for automotive PVB interlayer at 0.38 mm and 0.76 mm (15 and 30 mil).

The types of glass that may be used include but are not limited to: the common soda-lime variety typical of automotive glazing as well as aluminosilicate, lithium aluminosilicate, borosilicate, glass ceramics, and the various other inorganic solid amorphous compositions which undergo a glass transition and are classified as glass included those that are not transparent. The glass layers may be comprised of heat absorbing glass compositions as well as infrared reflecting and other types of coatings.

The glass layers may be annealed or strengthened. There are two processes that can be used to increase the strength of glass. They are thermal strengthening, in which the hot glass is rapidly cooled (quenched) and chemical tempering which achieves the same effect through an ion exchange chemical treatment. In the chemical tempering process, ions in and near the outside surface of the glass are exchanged with ions that are larger. These places the outer layer of glass in compression. Compressive strengths of up to 1,000 Mpa are possible.

Heat strengthened, full temper soda lime float glass, with a compressive strength in the range of at least 70 Mpa, can be used in all vehicle positions other than the windshield.

Heat strengthened (tempered) glass has a layer of high compression on the outside surfaces of the glass, balanced by tension on the inside of the glass which is produced by the rapid cooling of the hot softened glass. When tempered glass breaks, the tension and compression are no longer in balance and the glass breaks into small beads with dull edges. Tempered glass is much stronger than annealed laminated glass. The thickness limits of the typical automotive heat strengthening process are in the 3.2 mm to 3.6 mm range. This is due to the rapid heat transfer that is required. It is not possible to achieve the high surface compression needed with thinner glass using the typical blower type low pressure air quenching systems.

Laminated safety glass is made by bonding two sheets of glass, the outer glass layer 201 and the inner glass layer 202 of annealed glass together using a plastic bonding interlayer 4 comprised of a thin sheet of transparent plastic or thermos plastic layer as shown in FIG. 1. Annealed glass is glass that has been slowly cooled from the bending temperature down through the glass transition range. This process relieves any stress left in the glass from the bending process. Annealed glass breaks into large shards with sharp edges. When laminated glass breaks, the shards of broken glass are held together, much like the pieces of a jigsaw puzzle, by the plastic layer helping to maintain the structural integrity of the glass. A vehicle with a broken windshield can still be operated. The plastic bonding interlayer also helps to prevent penetration by objects striking the laminate from the exterior and in the event of a crash occupant retention is improved.

This black frit print obscuration on many automotive glazing serves both a functional and an aesthetic role. The substantially opaque black print on the glass serves to protect the poly-urethane adhesive used to bond the glass to the vehicle from ultra-violet light and the degradation that it can cause. It also serves to hide the adhesive from view from the exterior of the vehicle. The black obscuration must be durable, lasting the life of the vehicle under all exposure and weather conditions. Part of the aesthetic requirement is that the black have a dark glossy appearance and a consistent appearance from part to part and over the time. A part produced today must match up with one that was produced and in service 20 years ago. The parts must also match up with the other parts in the vehicle which may not have been fabricated by the same manufacturer or with the same formulation of frit. Standard automotive black enamel inks (frits) have been developed that can meet these requirements.

Black enamel frit is comprised of pigments, carriers, binders and finely ground glass. Other materials are also sometimes added to enhance certain properties: the firing temperate, anti-stick, chemical resistance, etc. The black frit is applied to the glass using a silk screen or ink jet printing process prior to the heating and bending of the glass. As the flat glass is heated during the bending process, the powdered glass in the frit softens and melts, fusing to the surface of the glass. The black print becomes a permanent part of the glass. The frit is said to be “fired” when this takes place. This is a vitrification process which is very similar to the process used to apply enamel finishes on bathroom fixtures, pottery, china and appliances.

The glass layers are formed using gravity bending, press bending, cold bending or any other conventional means known in the art. Gravity and press bending methods for forming glass are well known in the art and will not be discussed in the present disclosure.

Cold bending is a relatively new technology. As the name suggest, the glass is bent, while cold to its final shape, without the use of heat. On parts with minimal curvature a flat sheet of glass can be bent cold to the contour of the part. This is possible because as the thickness of glass decreases, the sheets become increasingly more flexible and can be bent without inducing stress levels high enough to significantly increase the long-term probability of breakage. Thin sheets of annealed soda-lime glass, in thicknesses of about 1 mm, can be bent to large radii cylindrical shapes (greater than 6 m). When the glass is chemically or heat strengthened the glass is able to endure much higher levels of stress and can be bent along both major axis. The process is primarily used to bend chemically tempered thin glass sheets (<=1 mm) to shape.

Cylindrical shapes can be formed with a radius in one direction of less than 4 meters. Shapes with compound bend, that is curvature in the direction of both principle axis can be formed with a radius of curvature in each direction of as small as approximately 8 meters. Of course, much depends upon the surface area of the parts and the types and thicknesses of the substrates.

The cold bent glass will remain in tension and tend to distort the shape of the bent layer that it is bonded to. Therefore, the bent layer must be compensated to offset the tension. For more complex shapes with a high level of curvature, the flat glass may need to be partially thermally bent prior to cold bending.

The glass to be cold bent is placed with a bent to shape layer and with a bonding layer placed between the glass to be cold bent and the bent glass layer. The assembly is placed in what is known as a vacuum bag. The vacuum bag is an airtight set of plastic sheets, enclosing the assembly and bonded together it the edges, which allows for the air to be evacuated from the assembly and which also applies pressure on the assembly forcing the layers into contact. The assembly, in the evacuated vacuum bag, is then heated to seal the assembly. The assembly is next placed into an autoclave which heats the assembly and applies high pressure. This completes the cold bending process as the flat glass at this point has conformed to the shape of the bent layer and is permanently affixed. The cold bending process is very similar to a standard vacuum bag/autoclave process, well known in the art, with the exception of having an unbent glass layer added to the stack of glass.

To control the level of light and energy transmission through the laminate, there are a number of technologies available. To incorporate into a laminate, sheets of plastic interlayer are needed on each side of the film so as to bond the film to the other layers of the laminate. The film is laminated in between two plastic bonding interlayers in order to form a laminated glazing.

The ability of change light transmittance and/or the attenuation of sound at lower temperatures proposed by the present invention is improved by adding a resistive heating circuit to the glazing.

Resistive heating circuits are commonly provided on automotive backlites in order to assist vision and enhance safety by melting snow and ice and clearing fog. Heating circuits are also provided on some windshields. On vehicles that have wipers that are hidden below the hood line when not in use, a heating wiper rest area is needed to keep the wipers clear of snow and ice when not in use and to prevent the buildup of snow in ice in the rest area when in use. Windshields that have safety cameras also require a heating circuit that can quickly clear the portion of the windshield in the camera field of view. Most vehicle are equipped with hot air windshield defrosting systems. Some are also provided with full windshield resistive heating as well. A number of technologies are in use in the production of the various types of heating circuits. In general, for most climates and typical glazing, a power density of at least 4-5 watts per square decimeter is required for good de-ice performance. For more demanding applications, such as the wiper rest area, power densities as high as 15 watts per square decimeter are known.

The optimum switching temperature is somewhere around 10-20 C although it will vary with the technology and the manufacturer. Likewise, the lower end of the range varies. A power density in the 2.5-3 watt range is sufficient to raise and maintain the temperature of the switchable material at a close to optimal temperature. The actual power density of the circuit will depend upon the technology, the position of the glazing and the manufacturer.

Several types of resistive heating circuits are used in automotive glazing. All can be used in embodiments of the invention.

Full surface windshield heating is commonly provided thought the use of a conductive transparent coating. The coating is vacuum sputtered directly onto the glass and is comprised of multiple layers of metal and dielectrics. With resistances in the range of 2-6 ohms per square, a voltage convertor is needed to reach the power density required. The lower power density required to maintain switching may allow for the use of a standard 12 V electrical supply.

Silver frit is the most common type of heating circuit used for backlites, heating wiper rests and camera defrosters. It is also the most cost effective. Finely silver powder is mixed with carriers, binders and finely ground glass. Other materials are also sometimes added to enhance certain properties: the firing temperate, anti-stick, chemical resistance, etc. The silver frit is applied to the glass using a silk screen or ink jet printing process prior to the heating and bending of the glass. As the flat glass is heated during the bending process, the powdered glass in the frit softens and melts, fusing to the surface of the glass. The silver frit print becomes a permanent part of the glass. The frit is said to be “fired” when this takes place. This is a vitrification process which is very similar to the process used to apply enamel finishes on bathroom fixtures, pottery, china and appliances. Resistances as low as 2 milliohms per square and line widths as narrow as 0.5 mm are possible. The primary drawback to silver print is the aesthetics of the fired silver which has a dark orange to mustard yellow color depending upon which side of the glass it is printed on, the air side or the tin side.

A transparent conductive coated film can also be used to provide for a resistive heating circuit. This is very similar too and made in the same manner that transparent conductive coated glass is made. A voltage convertor is needed to reach the power density required for windshield full surface heating. The lower power density of the invention may allow for the use of a standard 12 V electrical supply.

An embedded wire resistive heating circuit is formed by embedding fine wires into the plastic bonding layer of a laminate. The wires are embedded in the plastic through the use of heat or ultra-sound. Tungsten is a preferred material due to its tensile strength, which is 10× that of Copper and it flat black color. Heating windshields typically use tungsten wire that is in the 18-22 μm range at which point the wires are virtually invisible. The wires are embedded using an oscillating sinusoidal like pattern to reduce glare that can occur under certain lighting conditions. For positions of the glazing other than the windshield, larger wire diameters can be used. Wire are typically embedded utilizing some sort of CNC machine.

A micro-mesh resistive heating circuit is comprised of very fine conductive lines which are deposited onto a non-conductive substrate such as glass or plastic using a vacuum sputtering technique. Patterns are formed by masking of the substrate using a lithographic process similar to that used to produce integrated circuits. Line widths of 10 μm are possible, at which point, the mesh is invisible for all practical purposes. The primary advantage of this method is that the pattern can be designed to provide for very precise control of the heating. As the conductors do not need to be transparent, the thickness can be much great than that which is possible when coating the entire substrate. The process is also simpler as only a single metal layer is required.

The heating circuit may be operated in a manual or automatic manner. Both methods have been used for deice and defog applications. The circuit may be operated in response to the user. Generally, a timer is used to limit the power consumption and to prevent overheating. Temperature feedback may be provided for closed loop control. As most modern vehicles have interior and exterior temperature sensors, the vehicle climate control may operate the circuit based upon the temperature. For optimum efficiency, a light sensor may be used to detect the switching speed and operating the heating circuit in response to the measured switching speed and the temperature.

A panoramic windshield is a windshield on which the top edge has been substantially extended such that it comprises a portion of the vehicle roof.

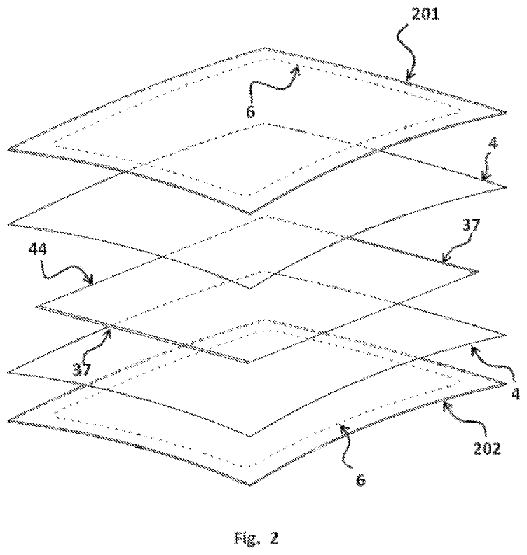

The laminated panoramic glass roof of FIG. 2, illustrates the prior art. The laminate is comprised of a standard soda-lime 2.5 mm thick clear outer glass layer 201 and a 2.1 mm soda-lime solar green inner glass layer 202. Obscuration 6 is screen printed on surface two 102 and surface four 104. The glass layers are thermally bent using a gravity bending process. A layer of SPD film 44, with bus bars 37 on opposite ends, is sandwiched between two layers of clear plastic bonding interlayer 4. The laminated panoramic glass roof operates in environmental temperatures in a range of about 0° C. to 60° C. In these conditions, the SPD film 44 has a light transmittance of 20% in the ON state (dark to clear) with a response time in a range of 1 s to 5 s and 2% in the OFF state (clear to dark) with a response time in a range of 5 s to 10 s, to the unpowered state.

The assembled laminated is processed, using standard automotive laminating equipment.

It should be understood that while the switchable technology of the embodiments is SPD, the same heating circuits may be incorporated into laminates which utilize other switchable technologies. Likewise, although the exemplary embodiments are panoramic roofs, the same heating circuits may be incorporated into acoustic laminates design for use as a windshield, rear window, door window or in any other glazed position of the vehicle.

### DETAILED DESCRIPTION OF THE EMBODIMENTS

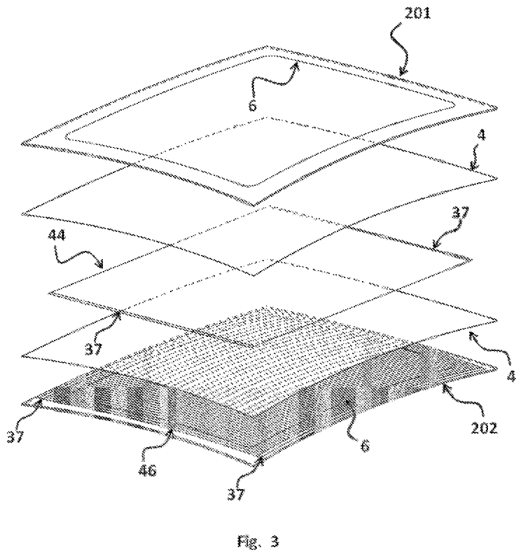

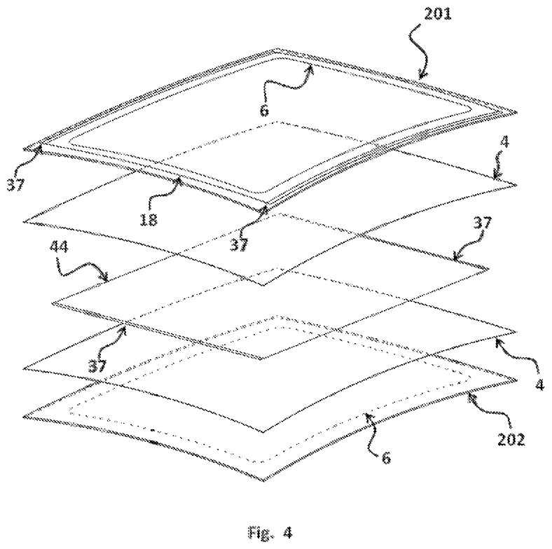

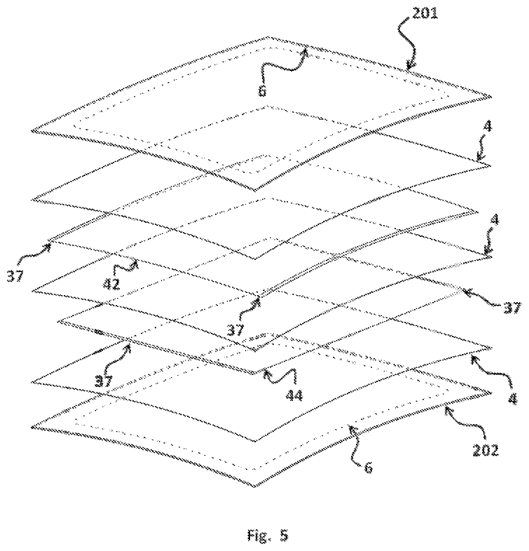

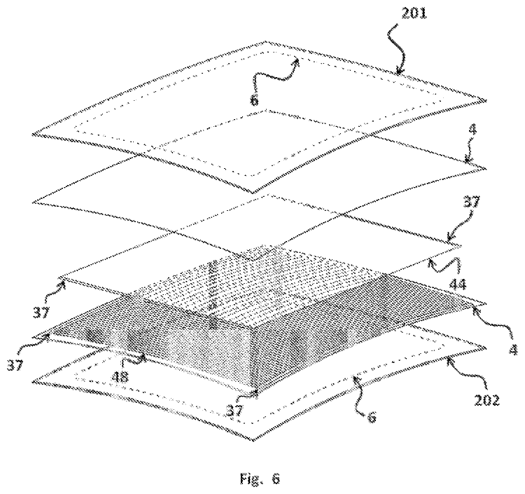

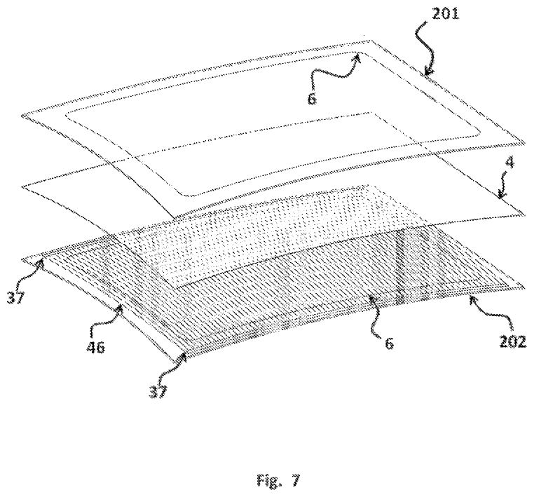

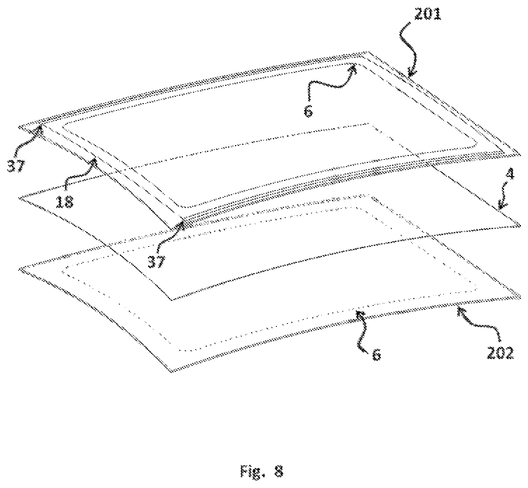

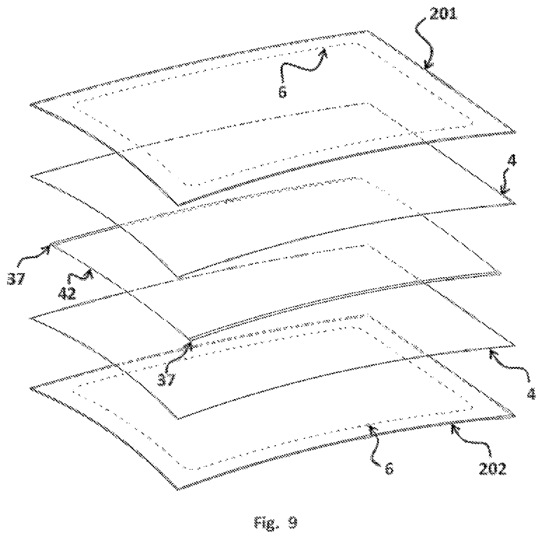

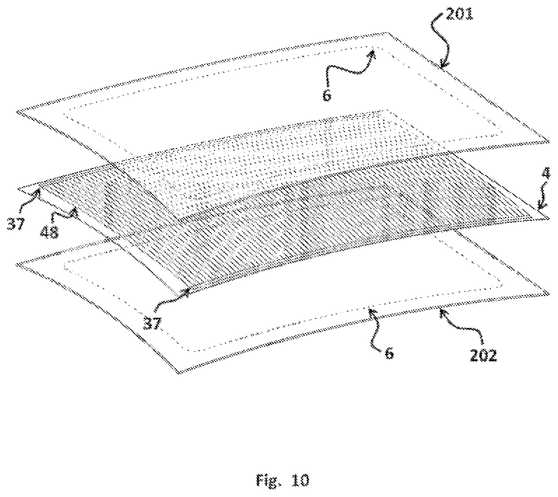

1. The laminated panoramic glass roof of FIG. 3 illustrates the first embodiment. The laminate is comprised of a standard soda-lime 2.5 mm thick clear outer glass layer 201 and a 2.1 mm soda-lime solar green inner glass layer 202. Obscuration 6 is screen printed on surface two 102 and surface four 104. A silver frit heating circuit 46, with 0.6 mm wide lines and a power density of 3 watts per decimeter squared is screen printed on the surface four 104. Screen printed silver frit bus bars 37 are used to connect the printed heater lines. The glass layers are thermally bent using a gravity bending process. A layer of SPD film 44, with bus bars 37 on opposite ends, is sandwiched between two layers of clear plastic bonding interlayer 4. The laminated panoramic glass roof of the embodiment operates in environmental temperatures less than to 0° C. The SPD film 44 has a light transmittance of 20% in the ON state with a response time in a range of 1 s to 5 s to switch from dark to clear and 2% in the OFF state with a response time in a range of 5 s to 10 s to switch from clear to dark, to the unpowered state. The assembled laminated is processed, using standard automotive laminating equipment.
2. The laminated panoramic glass roof of FIG. 4 illustrates the second embodiment. The laminate is comprised of a standard soda-lime 2.5 mm thick clear outer glass layer 201 and a 2.1 mm soda-lime solar green inner glass layer 202. Obscuration 6 is screen printed on surface two 102 and surface four 104. After printing, the outer glass layer 201 is heated to fire the black print. After firing, the outer layer is coated by means of a MSVD process to apply a transparent silver-based coating 18 having a sheet resistance of 2.5 ohms per square. At 12 V, the heating circuit has a power density of 3 watts per decimeter square. Thin flat tinned copper bus bars 37 are used to power the coated heater circuits. The glass layers are thermally bent using a gravity bending process. A layer of SPD film 44, with bus bars 37 on opposite ends, is sandwiched between two layers of clear plastic bonding interlayer 4. The laminated panoramic glass roof of the embodiment operates in environmental temperatures less than to 0° C. The SPD film 44 has a light transmittance of 20% in the ON state with a response time in a range of 1 s to 5 s to switch from dark to clear and 2% in the OFF state with a response time in a range of 5 s to 10 s to switch from clear to dark, to the unpowered state. The assembled laminated is processed, using standard automotive laminating equipment.
3. The laminated panoramic glass roof of FIG. 5 illustrates the third embodiment. The laminate is comprised of a standard soda-lime 2.5 mm thick clear outer glass layer 201 and a 2.1 mm soda-lime solar green inner glass layer 202. Obscuration 6 is screen printed on surface two 102 and surface four 104. The heating circuit is comprised of a plastic coated film 42 by means of a MSVD process used to apply a transparent silver-based coating having a sheet resistance of 2.5 ohms per square. At 12 V, the heating circuit has a power density of 3 watts per decimeter square. Thin flat tinned copper bus bars are used to power the coated heater circuit. The glass layers are thermally bent using a gravity bending process. A layer of SPD film 44, with bus bars 37 on opposite ends, is sandwiched between two layers of clear plastic bonding interlayer 4. The laminated panoramic glass roof of the embodiment operates in environmental temperatures less than to 0° C. The SPD film 44 has a light transmittance of 20% in the ON state with a response time in a range of 1 s to 5 s to switch from dark to clear and 2% in the OFF state with a response time in a range of 5 s to 10 s to switch from clear to dark, to the unpowered state. A layer of clear plastic bonding interlayer 4 bonds the SPD film 44 to the conductive coated film 42 and a third clear plastic bonding interlayer 4 is added to bond the coated film to the outer glass 201. The assembled laminated is processed, using standard automotive laminating equipment.
4. The laminated panoramic glass roof of FIG. 6 illustrates the forth embodiment. The laminate is comprised of a standard soda-lime 2.5 mm thick clear outer glass layer 201 and a 0.7 mm chemically tempered inner glass layer 202. Obscuration 6 is screen printed on surface two 102. An embedded tungsten wire heating circuit 48, with a power density of 3 watts per decimeter squared is embedded into the clear plastic bonding interlayer that is positioned between the SPD film 44 and the inner glass layer 202. Thin tinned copper bus bars are used to provide 12 V power to the wire heating elements. The outer glass layer 201 is thermally bent using a gravity bending process. The inner glass layer 202, is cold bent. A layer of SPD film 44, with bus bars 37 on opposite ends, is sandwiched between two layers of clear plastic bonding interlayer 4. The laminated panoramic glass roof of the embodiment operates in environmental temperatures less than to 0° C. The SPD film 44 has a light transmittance of 20% in the ON state with a response time in a range of 1 s to 5 s to switch from dark to clear and 2% in the OFF state with a response time in a range of 5 s to 10 s to switch from clear to dark, to the unpowered state. The assembled laminated is processed, using standard automotive laminating equipment.
5. Embodiment 5 is the same as embodiment 1 but with a PDLC film replacing the SPD.
6. Embodiment 6 is the same as embodiment 2 but with a PDLC film replacing the SPD.
7. Embodiment 7 is the same as embodiment 3 but with a PDLC film replacing the SPD.
8. Embodiment 8 is the same as embodiment 4 but with a PDLC film replacing the SPD.
9. The laminated panoramic glass roof of FIG. 7 illustrates the first embodiment. The laminate is comprised of a standard soda-lime 2.5 mm thick clear outer glass layer 201 and a 2.1 mm soda-lime solar green inner glass layer 202. Obscuration 6 is screen printed on surface two 102 and surface four 104. A silver frit heating circuit 46, with 0.6 mm wide lines and a power density of 3 watts per decimeter squared is screen printed on surface four 104. Screen printed silver frit bus bars 37 are used to connect the printed heater lines. The glass layers are thermally bent using a gravity bending process. The assembled laminated is processed, using standard automotive laminating equipment.
10. The laminated panoramic glass roof of FIG. 8 illustrates the second embodiment. The laminate is comprised of a standard soda-lime 2.5 mm thick clear outer glass layer 201 and a 2.1 mm soda-lime solar green inner glass layer 202. Obscuration 6 is screen printed on surface two 102 and surface four 104. After printing, the outer glass layer 201 is heated to fire the black print. After firing, the outer layer is coated my means of a MSVD process to apply a transparent silver based coating having a sheet resistance of 2.5 ohms per square. At 12 V, the heating circuit has a power density of 3 watts per decimeter square. Thin flat tinned copper bus bars 37 are used to power the coated heater circuits. The glass layers are thermally bent using a gravity bending process. The assembled laminated is processed, using standard automotive laminating equipment.
11. The laminated panoramic glass roof of FIG. 9 illustrates the third embodiment. The laminate is comprised of a standard soda-lime 2.5 mm thick clear outer glass layer 201 and a 2.1 mm soda-lime solar green inner glass layer 202. Obscuration 6 is screen printed on surface two 102 and surface four 104. The heating circuit is comprised of a plastic film coated (coated film 42) by means of a MSVD process used to apply a transparent silver-based coating having a sheet resistance of 2.5 ohms per square. At 12 V, the heating circuit has a power density of 3 watts per decimeter square. Thin flat tinned copper bus bars 37 are used to power the coated heater circuit. The glass layers are thermally bent using a gravity bending process. The assembled laminated is processed, using standard automotive laminating equipment.
12. The laminated panoramic glass roof of FIG. 10 illustrates the forth embodiment. The laminate is comprised of a standard soda-lime 2.5 mm thick clear outer glass layer 201 and a 0.7 mm chemically tempered inner glass layer 202. Obscuration 6 is screen printed on surface two 102. An embedded tungsten wire heating circuit 48, with a power density of 3 watts per decimeter squared is embedded into the clear plastic bonding interlayer. Thin tinned copper bus bars 37 are used to provide 12 V power to the wire heating elements. The outer glass layer 201 is thermally bent using a gravity bending process. The inner glass layer 202 is cold bent. The assembled laminated is processed, using standard automotive laminating equipment.

It can be noted that in embodiments 1 to 8, the laminated panoramic glass roof is also able to operate in environmental temperatures in a range of about 0° C. to 60° C. with an SPD performance as mentioned before.

It must be understood that this invention is not limited to the embodiments described and illustrated above. A person skilled in the art will understand that numerous variations and/or modifications can be carried out that do not depart from the spirit of the invention, which is only defined by the following claims.

What is claimed is:

1. A laminated glazing comprising:
an outer glass layer;
an interior glass layer;
at least one functional layer located between outer and inner glass layers; and
at least one resistive heating circuit located between the functional layer and one of the glass layers;
wherein said at least one resistive heating circuit provides heat to the functional layer to improve its response at low temperature.

2. The laminated glazing of claim 1, wherein at least one functional layer of said at least one functional layer is a switchable layer.

3. The laminated glazing of claim 1, wherein at least one functional layer of said at least one functional layer is an acoustic plastic interlayer.

4. The laminated glazing of claim 2, wherein the switchable layer has a response time in a range of about 1 s to 5 s to switch from dark to clear in environmental temperatures less than 0° C.

5. The laminated glazing of claim 2, wherein the switchable layer has a response time in a range of about 5 s to 10 s to switch from clear to dark in environmental temperatures less than 0° C.

6. The laminated glazing of claim 1 further comprising an infrared reflecting coating or an infrared reflecting film.

7. The laminated glazing of claim 2, wherein the switchable layer is selected from the group consisting of SPD, PDLC, LC and electrochromic.

8. The laminated glazing of claim 1, wherein the resistive heating circuit is selected from the group consisting of an embedded wire heating circuit, a silver frit heating circuit, a transparent conductive coated film heating circuit and a transparent conductive coated glass heating circuit.

9. The variable light transmittance laminated glazing of claim 1 wherein the interior glass layer is a cold bent glass layer.

10. The laminate of claim 1, wherein at least one of the glass layers is a chemically tempered glass layer.
